(19) United States
(12) Patent Application Publication
(10) Pub. No.: US 2005/0274446 A1
(43) Pub. Date: Dec. 15, 2005

(54) Metal fiber lamination method and system

(75) Inventor: Richard B. Evans, Maple Valley, WA (US)

Correspondence Address: BAKER & HOSTETLER LLP;Suite 1100, Washington Square, 1050 Connecticut Avenue, WASHINGTON, DC, 20036, US

(73) Assignee: The Boeing Company

(21) Appl. No.: 10/864,817

(22) Filed: Jun. 10, 2004

(51) Int. Cl. B32B 31/00; G05G 15/00

(52) U.S. Cl. 156/64; 156/250; 156/510; 156/351

(57) ABSTRACT

To generate a metal-fiber laminated item from a ply placed on a layup form, a tackifier is applied to the layup form, a first location on the layup form is determined to place the ply, and a second location on the layup form is determined to stop placing the ply. In addition, the ply is cut to generate a first edge that substantially conforms to the layup form at the first location in response to the first edge being different from the layup form at the first location and a temperature of the ply is modulated. Furthermore, the first edge is tacked to the layup form at the first location, the ply is applied along a natural path of the layup form between the first location and the second location, and the ply is cut to generate a second edge that substantially conforms to the layup form at the second location in response to the second edge being different from the layup form at the second location.

### FIELD OF THE INVENTION

The present invention generally relates to a system and method of generating a metal-fiber laminate item. More particularly, the present invention pertains to a system for auto lamination of a metal-fiber laminate to contour and its method of use.

### BACKGROUND OF THE INVENTION

Metal-fiber laminate structures are typically constructed from multiple layers or plies. These plies may include a variety of materials such as carbon fiber, various other fibers, metal films or foils, and the like. In addition, the plies may be pre-impregnated (if fiber) or coated (if foil) with a resin and are often dispensed from a roll or spool. In roll form, the composite ply material is referred to as “tape” and typically includes a paper backing film. This backing film generally prevents resin coated or pre-impregnated ply material (prepreg) from adhering to itself and aids in handling the ply as the ply is applied to the tool and the layup. At the beginning and end of each ply placement, the ply material is generally cut to match the profile of the layup while the backing film is left intact. To provide support for the material being cut and facilitate cutting to a proper depth, an anvil is typically utilized. The anvil is situated on the opposite side of the tape from the cutting tool and lays along the cutting path or is controlled to move in unison with the cutting tool. The intact backing film is utilized to guide the severed ply on to the layup.

A disadvantage associated with conventional anvils is the relatively high precision required to install and prepare them for use. Minor deviations in height adjustment may result in incomplete cuts of the ply material or cutting of the backing film. In particular, cuts in the backing film, introduced during the ply cutting procedure, often serve as a starting point for a tear. As the backing film is removed, torn backing film may remain on the ply, may fowl the ply placement head, and/or may lead to breakage of the backing film.

During the layup process, the backing film is removed prior to placement of any subsequent ply. A disadvantage associated with conventional backing film material is that it is a relatively thick calendered claycote type paper. The weight and thickness of this paper reduce the yardage of ply material that may be placed on a spool of a given diameter. Reducing the thickness of the conventional backing film in an effort to place more backed ply material on a spool, however, increases the tendency of the backing film to tear.

In addition, to facilitate adhesion of the ply material to the mold or tool, generally heat is applied to the ply material. However, removal of the backing is typically negatively effected by the application of heat. In particular, the backing may fail to release from the ply material.

Accordingly, it is desirable to provide a system for generating composite items that is capable of overcoming the disadvantages described herein at least to some extent.

### SUMMARY OF THE INVENTION

The foregoing needs are met, to a great extent, by the present invention, wherein in some embodiments a system for generating metal-fiber laminate items and a method of using such a system is provided.

An embodiment of the present invention relates to a method of generating a metal-fiber laminate item from a ply placed on a layup form. In this method, a tackifier is applied to the layup form, a first location on the layup form is determined to place the ply, and a second location on the layup form is determined to stop placing the ply. In addition, the ply is cut to generate a first edge that substantially conforms to the layup form at the first location in response to the first edge being different from the layup form at the first location and a temperature of the ply is modulated. Furthermore, the first edge is tacked to the layup form at the first location, the ply is applied along a natural path of the layup form between the first location and the second location, and the ply is cut to generate a second edge that substantially conforms to the layup form at the second location in response to the second edge being different from the layup form at the second location.

Another embodiment of the present invention pertains to an apparatus for generating a composite item from a ply placed on a layup form. The apparatus includes a means for applying a tackifier to the layup form, means for determining a first location on the layup form to place the ply, means for determining a second location on the layup form to stop placing the ply, and means for cutting the ply to generate a first edge that substantially conforms to the layup form at the first location in response to the first edge being different from the layup form at the first location. In addition, the apparatus includes a means for modulating a temperature of the ply, means for tacking the first edge to the layup form at the first location, means for applying the ply along a natural path of the layup form between the first location and the second location, and means for cutting the ply to generate a second edge that substantially conforms to the layup form at the second location in response to the second edge being different from the layup form at the second location.

Yet another embodiment of the present invention relates to a computer readable medium on which is embedded computer software comprising a set of instructions for executing a method of generating a composite item from a ply placed on a layup form. In this method, a tackifier is applied to the layup form, a first location on the layup form is determined to place the ply, and a second location on the layup form is determined to stop placing the ply. In addition, the ply is cut to generate a first edge that substantially conforms to the layup form at the first location in response to the first edge being different from the layup form at the first location and a temperature of the ply is modulated. Furthermore, the first edge is tacked to the layup form at the first location, the ply is applied along a natural path of the layup form between the first location and the second location, and the ply is cut to generate a second edge that substantially conforms to the layup form at the second location in response to the second edge being different from the layup form at the second location.

Yet another embodiment of the present invention pertains to a system for generating a composite item from a ply placed on a layup form. The system includes a contour tape lamination machine to move a dispensing head along a natural path across the layup form. The dispensing head includes a supply reel to retain a supply of the ply. The ply is withdrawn from the supply reel at a feed rate. The dispensing head further includes a heater assembly. The heater assembly is operable to impart thermal energy upon the ply in response to the feed rate.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a contour tape lamination machine suitable for use with a backed ply material according to an embodiment of the invention.

FIG. 2 is a perspective view of a backed ply material suitable for use with the embodiment of the invention illustrated in FIG. 1.

FIG. 3 is a simplified view of a tape laying head suitable for use with the embodiment of the invention illustrated in FIG. 1.

FIG. 4 is a perspective view of a cutter assembly suitable for use with the embodiment of the invention illustrated in FIG. 3.

FIG. 5 is a side view of an anvil suitable for use with the cutter assembly illustrated in FIG. 4.

FIG. 6 is a side view of another anvil suitable for use with the cutter assembly illustrated in FIG. 4.

FIG. 7 is a block diagram of a system for laminating a composite item according to an embodiment of the invention.

FIG. 8 is a system architecture for a controller suitable for use in the system according to FIG. 7.

FIG. 9 is a flow diagram for a method of placing according to an embodiment of the invention.

### DETAILED DESCRIPTION

The present invention provides, in some embodiments, a system for placing plies to generate a metal-fiber laminate item and a method of using this system. In an embodiment, the invention provides for a numerically controlled (NC) contoured tape lamination machine (CTLM). This lamination device includes a dispensing head to place plies upon a layup mold or tool. In addition, the lamination device includes a cutting assembly having an anvil for supporting cuts of a backed ply material.

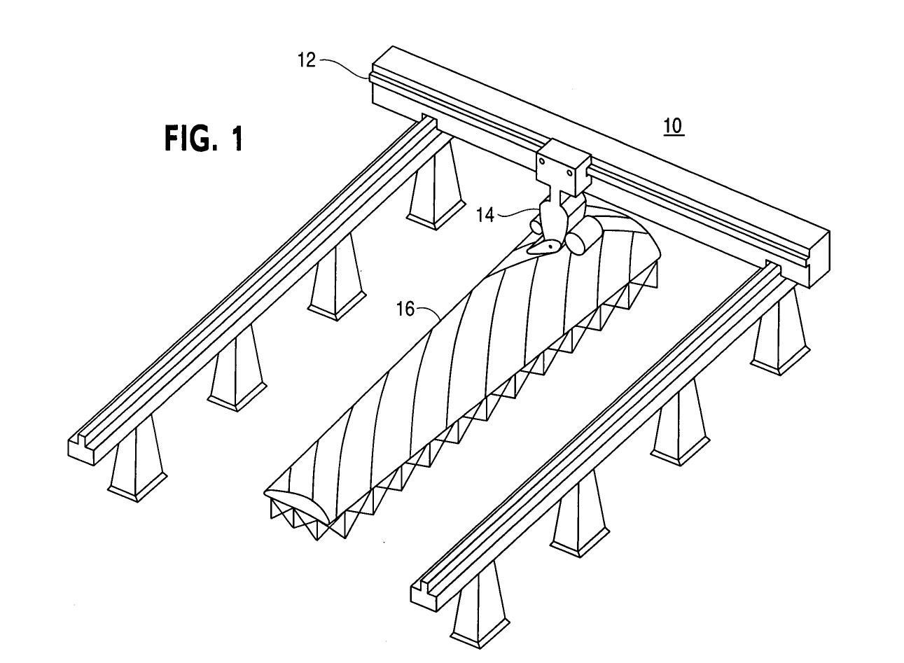

The invention will now be described with reference to the drawing figures, in which like reference numerals refer to like parts throughout. FIG. 1 is a perspective view of a contour tape lamination machine (CTLM) 10 suitable for use with a backed ply material according to an embodiment of the invention. As shown in FIG. 1, the CTLM 10 is of a gantry-type and, as such, includes a gantry 12, a tape laying head 14, and a layup mold or tool 16. The gantry 12 is configured to control the movement of the tape laying head 14 in relation to the tool 16 and a ply material is laid upon the tool 16. In an embodiment of the invention, the gantry 12 is configured to control ten axis of movement (five axis of the gantry and five axis of the tape laying head 14). However, it is to be understood that the specific number of axis may depend upon the particular operating condition and thus, the number of axis controlled is not critical to the invention.

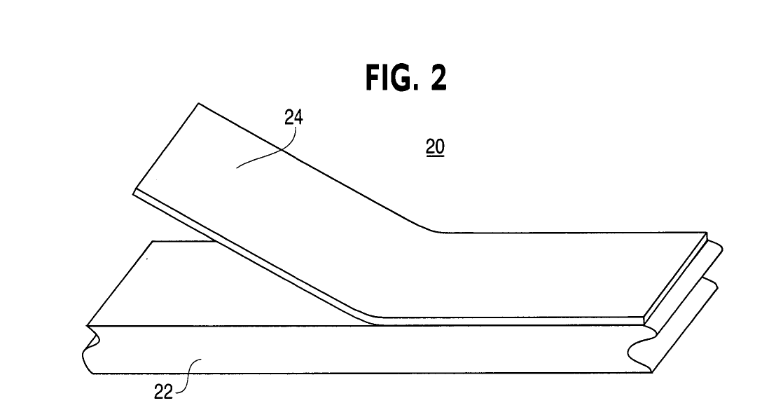

FIG. 2 is a perspective view of a backed ply material suitable for use with the embodiment of the invention illustrated in FIG. 1. As shown in FIG. 2, a backed ply material 20 includes a ply material 22 and a backing 24. In various embodiments of the invention, the ply material 22 may include any suitable sheet stock. Examples of suitable sheet stocks include: woven fiber fabric; oriented strand tape; metal foil such as aluminum alloy and titanium foil; composite materials such as titanium graphite composites; and the like. In a particular embodiment, the ply material 12 is a graphite fiber tape pre-impregnated with an epoxy resin (pre-preg). In another particular embodiment, the ply material 12 is an epoxy resin coated titanium foil.

In general, the backing 24 lends support to the ply material 22 and aids in handling the ply material 22. As described herein, the backed ply material 20 is typically rolled on to a spool in preparation for dispensing. For a given thickness of the ply material 22 rolled into a given diameter spool, the thickness of the backing 24 has an inversely proportional relationship with the length of ply material 22 that may be placed on the spool. That is, the thinner the backing 24, the more ply material 22 will fit onto the spool. Longer lengths of ply material 22 are generally preferred due to the decreased number of splices that must be prepared, reduced downtime as a result of the decreased number of splices, and reduced number of spool change operation to be performed. Thus, it is preferable that the backing 12 is thin. In addition, the thickness of this backing 24 is varied depending upon the particular application. For example, according to various embodiments of the invention, for typical composite layup applications, the thickness of the backing 24 is from about 0.001 inches (1 mil) to about 0.004 inches (4 mil). More preferably, the thickness of the backing 24 is about 1 mil to about 2 mil. However, in other embodiments, the thickness of the backing 24 is less than 1 mil. For example, when constructing relatively small and/or convoluted items such as, hand held or smaller devices, it may be advantageous that the ply material 22 be approximately 1 mil thick or less and the backing 24 be approximately 0.1 mil thick or less. In yet other embodiments, the thickness of the backing 24 is greater than 4 mil. For example, when constructing items with relatively thick (3 millimeters or more) or otherwise difficult to handle ply material 22, the backing 24 may be 10 or more mil thick.

During layup operations, the backing 24 is typically removed. To reduce down time, it is also preferable that the backing 24 is tear-resistant. For example, the backing 24 may include a plastic or otherwise tough resilient material. According to an embodiment of the invention, the backing 24 includes a suitable polyester film. Suitable polyester films include at least heat stabilized polyethylene terephthalate (PET). To further facilitate removal of the backing 24 from the ply material 22, the backing 24 optionally includes a suitable release agent. Suitable release agents include at least silicone release agents applied by Tribex Corp. of Rocklin Calif., USA. Optionally, the backing 24 is substantially transparent to facilitate inspection of seams between abutting plies. For example, a 2 mil film of PET is essentially transparent. In addition, other examples of suitable backing material and backed ply material may be found in co-pending U.S. patent application Ser. No. not yet assigned, entitled, “Backing Film and Method for Ply Materials”, having inventor Richard B. Evans, and having a filing date of Apr. 22, 2004, the disclosure of which is hereby incorporated by reference in its entirety.

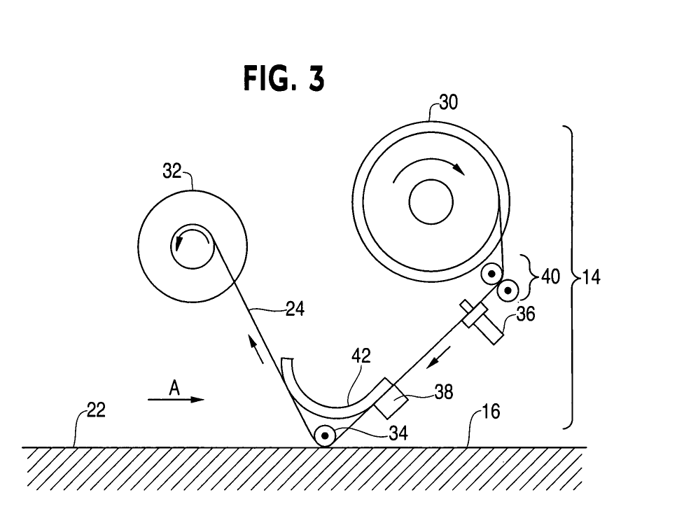

FIG. 3 is a simplified view of a tape laying head 14 suitable for use with the embodiment of the invention illustrated in FIG. 1. As shown in FIG. 3, the tape laying head 14 includes a supply spool 30, take-up reel 32, a shoe or compaction roller 34, cutting assembly 36, heater assembly 38, material feeder 40, and guide chute 42. The tape laying head 14 dispenses the ply material 22 upon a tool 16 as it moves in direction A relative to the tool 16. More particularly, the supply spool 30 and the take-up reel 32 rotate in the respectively indicated directions to cause backed ply material 20 to advance through the tape laying head 14 as indicated. The supply spool 30 and/or the take-up reel 32 are optionally controlled to rotate via the action of, for example, one or more servo axis motors. Following application of the ply material 22 upon the tool 16, the backing 24 is removed and collected by, for example, the take-up reel 32. However, the take-up reel 32 is optional and thus, the backing 24 may be removed in any suitable manner such as, for example, manually, a backing removal device, or the like. Depending upon the particular application, the placement of the ply material 22 may be inspected prior to removal of the backing 24. In this regard, it is an advantage of some embodiments of the invention that the backing 24 is substantially transparent and thus, the placement of the ply material 14 may be plainly visible through the backing 24.

The cutting assembly 36 may employ any known cutting device such as various bladed devices, abrasive cutters, high pressure jets, lasers, and the like. In a specific example, the cutting assembly 36 includes an ultrasonic knife that is caused to vibrate by an ultrasonic transducer and controlled to rotate by the action of a motor. The ultrasonic knife is further controlled to traverse the full width of the backed ply material 20 or any portion thereof by the action of a motor configured to rotate a jackscrew. Furthermore, the cutting assembly 36 may employ more than one cutting device. For example, the cutting assembly 36 of an embodiment of the invention includes two cutting devices controlled to perform cutting operations in a substantially simultaneous manner.

When utilizing specific materials and/or operating conditions in which heating of the material is advantageous, the heater assembly 38 is configured to impart thermal energy upon the backed ply material 20. In this regard, any known device operable to heat the backed ply material 20 in a suitable manner may be utilized by various embodiments of the invention. For example, the heater assembly 38 may include a diverter valve configured to control the flow of heated air directed onto the backed ply material 20. In addition, to the heater assembly 38, the tape laying head 14 may include various supplemental heaters such as, for example, a nip heater, a guide chute heater, a heater following the compaction roller 34, and the like.

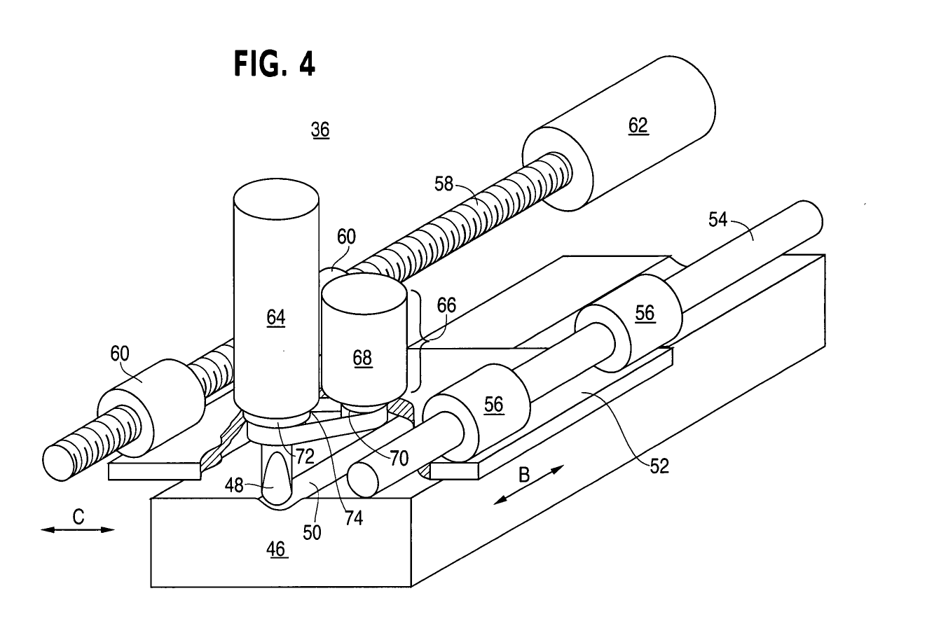

FIG. 4 is a perspective view of a cutter assembly suitable for use with the embodiment of the invention illustrated in FIG. 3. As shown in FIG. 4, the cutting assembly 36 includes an anvil 46 and a stylus 48. The anvil 46 and the stylus 48 are juxtaposed in co-operative alignment to facilitate cutting of ply material. That is, the anvil 46 provides support for the ply material and thereby facilitates the cutting action of the stylus 48. In various embodiments of the invention, the anvil 46 includes a groove 50 cooperatively aligned with the stylus 48. In a particular embodiment shown in FIG. 4, the groove 50 is coincidental with a path of the stylus 48. In this regard, the stylus 48 is mounted to a platform 52. Movement of this platform 52 may be controlled in any suitable manner. Examples of suitable movement control systems generally include guide and/or actuating devices such as rails, rack and pinions, linear drive belts, linear slides, X-Y tables, pneumatic rams, linear actuators, various armatures, and the like.

In a particular example shown in FIG. 4, the movement of the platform 52 is controlled by the action of a guide bar 54, pillow blocks 56, lead screw 58, and pillow blocks 60. The pillow blocks 56 slidably engage the guide bar 54. The pillow blocks 60 are tapped to mate with the threads of the lead screw 58. In addition, a servo motor 62 is controlled to rotate the lead screw 58 and thereby modulate the position of the stylus 48 along the groove 50. In this manner, the stylus 48 is controlled to move as indicated by direction B.

Depending upon the material to be cut and/or the particular application, the cutting assembly 36 may further include and ultrasonic transducer 64 and stylus orientation assembly 66. The ultrasonic transducer 64 generates vibrational energy that is transmitted through the stylus 48 and thereby facilitate cutting of various materials. The stylus orientation assembly 66 includes a servo motor 68, pulleys 70 and 72, and belt 74. To modulate the orientation of the stylus 48, the servo motor 32 is controlled to rotate the pulley 70. This rotation is transferred via the belt 74 to the pulley 72 which, in turn, causes the rotation of the stylus 48. In addition, other examples of suitable cutting assemblies and cutting anvils may be found in co-pending U.S. patent application Ser. No. not yet assigned, entitled, “Cutting Anvil and Method”, having inventor Richard B. Evans, and having a filing date of Apr. 22, 2004, the disclosure of which is hereby incorporated by reference in its entirety.

In operation, a sheet of ply material or the backed ply material 20 is fed between the platform 52 and the anvil 46 and generally controlled to move as indicated by direction C. By controlling the movement of the ply material in conjunction with the movement of the various components of the cutting assembly 36, the cutting assembly 36 is controllable to generate slitting cuts, butt cuts, tapers, curves, and the like.

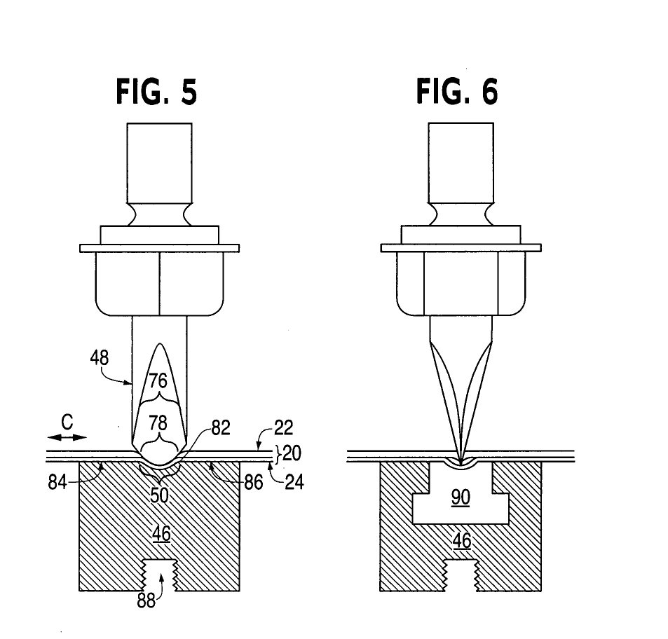

As shown in FIG. 5, the anvil 46 includes the groove 50. As stated herein, the groove 50 is cooperatively aligned with the stylus 48. In particular, the groove 50 is aligned with an edge 76 of the stylus 48 and, more particularly, the groove 50 is aligned with a tip 78 of the stylus 48.

According to an embodiment of the invention, the cutting assembly 36 is operable to cut a backed ply material 20. In this regard, the backed ply material 20 includes a ply material 22 and a backing 24. In various embodiments of the invention, the ply material 22 may include any suitable sheet stock. Examples of suitable sheet stocks include: woven fiber fabric; oriented strand tape; metal foil such as aluminum alloy and titanium foil; composite materials such as titanium graphite composites; and the like. In a particular embodiment, the ply material 22 is a graphite fiber tape pre-impregnated with an epoxy resin (pre-preg). In another particular embodiment, the ply material 22 is an epoxy resin coated titanium foil. In general, the backing 24 lends support to the ply material 22 and aids in handling the ply material 22. In this regard, during layup operations, the backing 24 is typically removed.

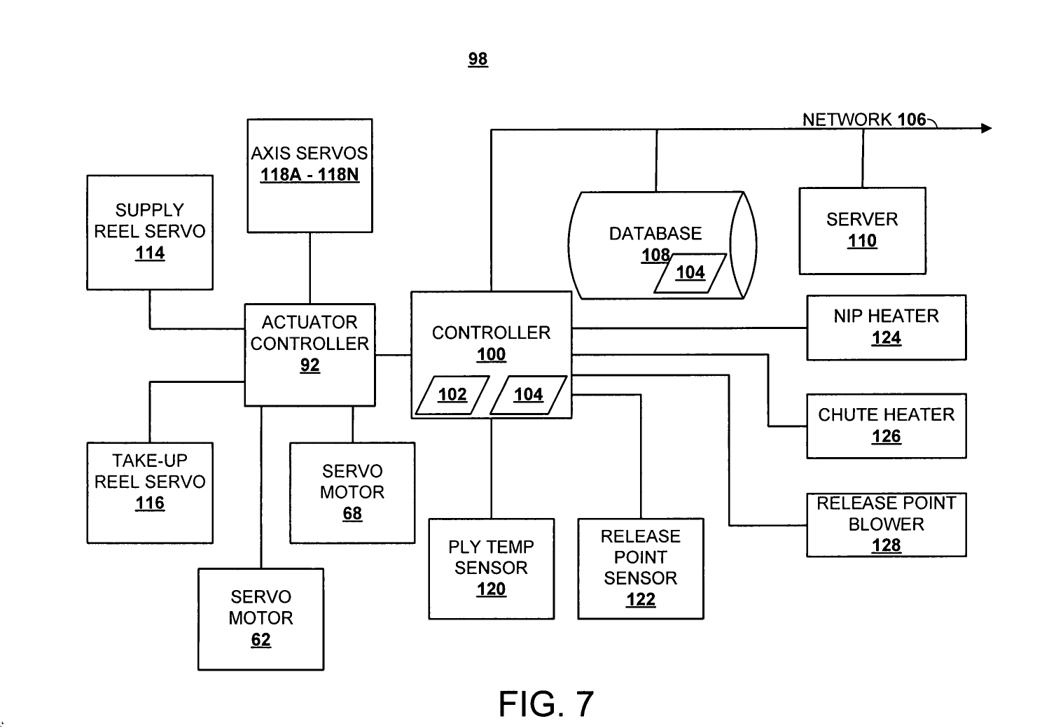

In operation, the backed ply material 20 is moved, relative to the stylus 48. Oriented as indicated by the direction C, the cutting assembly 36 is configured to produce a slitting operation. As shown in FIG. 6, the stylus 48 is oriented to produce a butt cut. That is, the stylus 48 is drawn across the backed ply material 20 while the backed ply material 20 remains essentially stationary. In addition, taper cuts may be produced by disposing the stylus 48 at a desired orientation and moving both the stylus 48 and the backed ply material 20 in a substantially simultaneous and cooperative manner. During the various operations, the ply material 22 is cut while the backing 24 passes between the tip 78 and the groove 50. In this regard, according to an embodiment of the invention, the stylus 48 and the anvil 46 do not touch during ply cutting operations. That is, a gap 82 is substantially maintained between the edge 76 and the groove 50. This gap 82 is generally set prior to ply cutting operations. It is an advantage of some embodiments of the invention that the cutting assembly 36 properly cuts the ply material 22 without cutting the backing 24 through a greater range of gap settings than conventional cutting assemblies. As such, setting the gap 82 is relatively easier and faster than setting the gap in conventional cutting assemblies.

Optionally, the anvil 46 includes a pair of transition surfaces 84 and 86 and a tapped bore 88. The transition surfaces 84 and 86, if present, facilitate alignment of the groove 16 with any suitable surface and/or tape guide. That is, according to an embodiment of the invention, the cutting assembly 36 is installed within a tape chute of a tape laying head. The tape chute includes surfaces and/or devices that guide the tape through the tape chute. When the anvil 46 is installed in the tape laying head, the groove 50 is typically aligned with the surfaces and/or devices that guide the tape through the tape chute. In some embodiments, the transition surfaces 84 and 86 facilitate this alignment. However, in other embodiments, the groove 50 aligned without the surfaces and/or devices that guide the tape through the tape chute.

The tapped bore 88, if present, facilitates securing the anvil 46 to the cutting assembly 36. For example, a threaded bolt configured to engage the tapped bore 88, may be utilized to secure the anvil 46 to a case or frame member of the cutting assembly 36 and/or other such structures of a tape laying head. However, the anvil 46 need not be secured in this manner, but rather, the anvil 46 may be secured relative to the stylus 48 via any suitable fastening device.

FIG. 6 is a side view of the anvil 46 according to another embodiment of the invention. The embodiment illustrated in FIG. 6 is similar to the embodiment illustrated in FIG. 5. Therefore, in the interest of brevity, those elements described in FIG. 5 will not be described again with reference to FIG. 6. As shown in FIG. 6, the anvil 46 includes an insert 90. The insert 90 is secured to the anvil 46 in any suitable manner. For example, according to an embodiment of the invention, the insert 90 is machined to mate with a “T” slot machined into the anvil 46. In this manner, the insert 90 may be removably secured without the aid of an adhesive. In another example, the insert 90 may be affixed to the anvil 46 with an adhesive or mechanical fastener. Material for use as the insert 90 include any suitable materials having relatively good wear properties and a relatively low coefficient of friction. Material for use as the insert 60 include any suitable materials having relatively good wear properties and a relatively low coefficient of friction. Examples of suitable materials generally include plastics, resins, and the like. Specific examples of suitable materials include one or more of: ultra high molecular weight (UHMW) polyethylene polymers; Delrin®; nylon, acetal; and the like.

FIG. 7 is a block diagram of a system 98 suitable for use with the CTLM 10. As shown in FIG. 7, the system 98 includes a controller 100. The controller 100 is operable to execute computer readable code. In this regard, the system 98 includes a set of computer readable instructions or code 102. According to the code 102, the controller 100 is configured to access a file 104. This file 104 includes one or more of the following: a computer readable model of the composite item; a computer readable representation of the surface of the layup form or the tool 16; a computer readable representation of the edges of the tool 16; the thickness of the composite item; a source code based upon at least one of the composite item and the tool 16; a set of movement instructions based upon the source code; data gathered while laying up the composite item; timestamp information; positional information; identification numbers; and the like. The controller 100 is further configured to communicate across a network 106. The network 106 is optionally included to provide additional data storage and/or processing capabilities. In this regard, the network includes a database 108 and a server 110. The database 108 is configured to store a copy of the file 104. The server 110 is configured to generate, store, and perform any suitable processing of the file 104. In this manner, composite items generated on computer assisted design (CAD) machines such as the server 110, for example, may be forwarded to the CTLM 10. In addition, the server 110 is operable, via the network 106, to forward updates for the code 102.

Also shown in FIG. 7 is an servo controller 112. The servo controller 112 is optionally included in the system 98 depending upon the requirements of the various actuators and/or servo motors of the CTLM 10. That is, depending upon the particular configuration of the CTLM 10, a plurality of actuators and/or servo motors, such as the servo motors 62 and 68 for example, may be utilized to control the various components of the CTLM 10. The servo controller 112, if present, is configured to control some or all of these actuators and/or servo motors of the actuator 44 is operable to be modulated by the controller 100 directly, the system 98 may not include the servo controller 112. In addition, the servo controller is configured to control any suitable actuator and/or servo. Suitable servo motors include a supply reel servo 114, take-up reel servo 116, axis servos 118a to 118n, and the like. In this regard, the supply reel servo 114 and take-up reel servo 116 are configured to modulate the position, speed, direction, tension, and the like of the backing 24 and thereby modulate at least these attributes of the ply material 22. Furthermore, the axis servos 118a to 118n are configured to modulate the rotation, position, speed, direction, and the like of the various components of the CTLM 10. More particularly, the axis servos 118a to 118n are at least configured to modulate the x-, y-, z-, c-, a-, d-, e-, q-, v-, and u-axes of the tape laying head 14 and/or CTLM 10. If present, parameters of the servo controller 112 are based upon the specification of the various servos and the controller 100.

The system 98 further includes a plurality of sensors configured to sense the various operating conditions of the CTLM 10. More particularly, the system 98 optionally includes sensors to sense the ply temperature, the temperature at the location where the backing 24 is separated from the ply material 22 (release point), feed rate and direction, ply placement, backing integrity, supply of ply material, and the like. In a specific example, the system 98 includes a ply temperature sensor 120 and a release point sensor 122. The ply temperature sensor 120 senses the temperature of the ply material 22 at or near the point that the ply material 22 is applied to the tool 16 and forwards signals to the controller 100 in response to the ply temperature. The release point sensor 122 senses the temperature of backing 24 and/or the ply material 22 at or near the release point and forwards signals to the controller 100 in response to the backing 24 and/or ply material 22 temperature.

To modulate the temperature of the tool 16, the ply material 22 and/or the backing 24, the system 98 optionally includes a nip heater 124, chute heater 126, and release point blower 128. If present, these devices are modulated by the controller 100. The nip heater 124 applies a controlled amount of heat to the tool 16, the ply material 22 and/or the backing 24 in response to controlling signals generated by the controller 100. Similarly, the chute heater 126 applies a controlled amount of heat to the ply material 22 and/or the backing 24 in response to controlling signals generated by the controller 100. In addition, the release point blower directs a flow of air toward the release point in response to controlling signals generated by the controller 100.

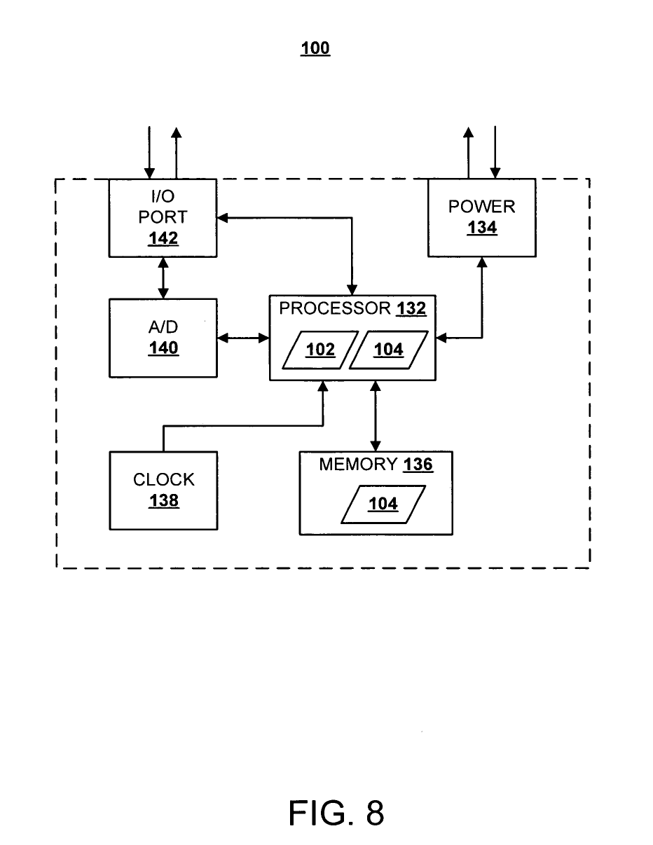

FIG. 8 is a system architecture for the controller 100 suitable for use in the system 98. As shown in FIG. 4, the controller 100 includes a processor 132. This processor 132 is operably connected to a power supply 134, memory 136, clock 138, analog to digital converter (A/D) 140, and an input/output (I/O) port 142. The I/O port 142 is configured to receive signals from any suitably attached electronic device and forward these signals to the A/D 140 and/or the processor 132. If the signals are in analog format, the signals may proceed via the A/D 140. In this regard, the A/D 140 is configured to receive analog format signals and convert these signals into corresponding digital format signals. Conversely, the A/D 140 is configured to receive digital format signals from the processor 132, convert these signals to analog format, and forward the analog signals to the I/O port 142. In this manner, electronic devices configured to receive analog signals may intercommunicate with the processor 132.

The processor 132 is configured to receive and transmit signals to and from the A/D 140 and/or the I/O port 142. The processor 132 is further configured to receive time signals from the clock 138. In addition, the processor 132 is configured to store and retrieve electronic data to and from the memory 136. Furthermore, the processor 132 is configured to determine signals operable to modulate the servo controller 112 and thereby control the various actuators and/or servo motors of the CTLM 10 to exert a particular force and/or rotate to a particular degree. For example, signals associated with rotating the servo motor 68 in the counterclockwise direction may be forwarded to the servo controller 112 by the processor 132 via the I/O port 142.

According to an embodiment of the invention, the processor 132 is configured to execute the code 102. Based on this set of instructions and signals from the various components of the CTLM 10, the processor 132 is configured to: determine a set of movement instructions; modulate the nip heater 124, chute heater 126, and release point blower 128 in response to the feed rate of the ply material 22, and the like.

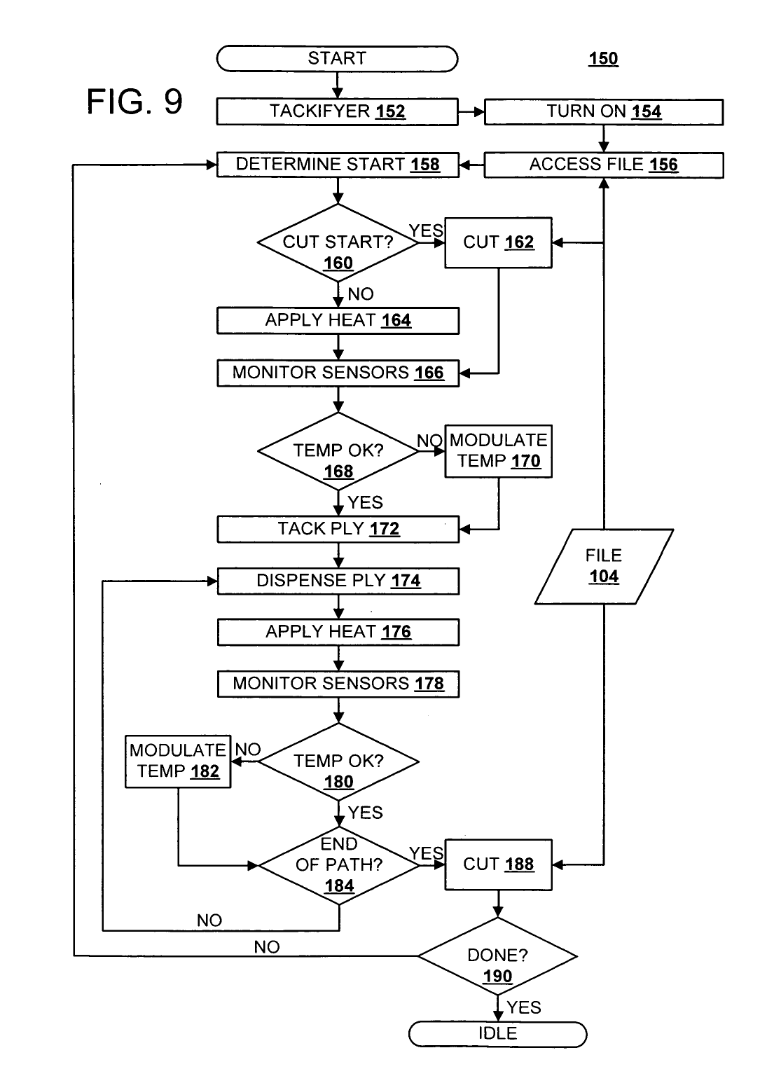

FIG. 9 illustrates steps involved in a method 150 of placing plies to produce a composite structure or product. Prior to the initiation of the method 150, a composite product is designed and a series of computer readable instructions specifying attributes of the composite product is generated. These instructions are utilized to control the operations of the CTLM 10 and construct a form such as the tool 16. This tool 16 or lay-up form is further positioned within the operational area of the CTLM 10.

At step 152, the method 150 is initiated by applying a tackifier resin to the tool 16. Tackifier resins modify the rheological properties of an adhesive system. These tackifiers are combined with base polymers/elastomers in adhesives to improve the tack or ability to stick. In general this property is achieved by an increased wetting out onto a surface and improved specific adhesion. More specifically, by modulating the tackifier and base resin combination, the viscoelastic behavior of the adhesive is varied. In addition, the particular tackifier utilized is typically dependent upon its suitability or compatibility with the base resin. For example, in a resinous base composition including a polyamide elastomer and/or an oxymethylene copolymer, suitable tackifiers may include: Toray E-09 manufactured by Toray Composites (America) of Tacoma, Wash.; MSR 355-HSC manufactured by The Boeing Company of Chicago, Ill.; and the like. However, the invention is not limited to the use of a particular base resin and its compatible tackifiers, but rather, any suitable resin and base/tackifier resin system is within the scope of embodiments of the invention. turning on the various components of the CTLM 10 described herein above and executing the computer readable instructions according to the file 104.

To apply the tackifier resin to the tool 16, a low nap roller and/or any suitable spray system is utilized to deposit a substantially even coat of tackifier resin diluted with a compatible solvent. Suitable spray systems include high volume low pressure (HVLP), high pressure low volume (HPLV), and the like. Examples of a suitable tackifier resins, dilution factors, and compatible solvents include: Toray E-09 in 22% weight/volume acetone; MSR 355-HSC in 10% weight/volume acetone; and the like. Following the application of the tackifier, the solvent may be allowed to evaporate or “flash off.” In this manner a relatively thin and substantially even coating of tackifier resin is applied to the tool 16.

At step 154 the CTLM 10 is powered or turned on and any suitable initiation subroutines and/or system checks are performed. In an embodiment, as a safety precaution, the CTLM 10 is powered following the application of the tackifier and after all personnel have moved away from the tool 16. However, the CTLM 10 need not be powered following the application of the tackifier. In this regard, according to another embodiment, the CTLM 10 includes a tackifier application assembly configured to apply the tackifier resin to the tool 16.

At step 156 the file 104 is accessed. In response to accessing the file 104 at step 156, a starting point to begin laying the ply material 22 is determined at step 158. That is, based upon the computer readable set of instructions, a location on the tool 16 is determined.

At step 160 it is determined whether the ply material 22 is to be cut. For example, the profile of the ply material 22 may be determined based upon the file 104. This profile may be compared to the last profile the ply material 22 was cut at. If the profiles essentially match, then the ply material 22 may not need to be cut. If the profiles do not match then, the ply material 22 may be cut at step 162. If it is determined that the ply material 22 is to be cut then, at step 162, the ply material 22 is cut. If it is determined that the ply material is not to be cut then, at step 164, the sensors are monitored.

At step 162 the ply material 22 is cut in accordance with the profile specified in the file 104. For example, the supply reel servo 114, the take-up reel servo 116, and/or the cutting assembly 36 may be modulated via the controller 100 to perform the cut as specified in the file 104. In a particular example, cutting of the ply material 22 may be performed at a controlled depth of cut so as to substantially sever the ply material 22 while leaving the backing 24 essentially uncut.

At step 164 heat is applied to one or more locations. For example, heat may be applied at the heater assembly 38, the guide chute 42, and/or the like. In this manner, the viscoelastic behavior of temperature sensitive adhesives may be varied. In particular, heat is applied to the end of the ply material 22 being tacked to the tool 16 to facilitate adherence of the ply material 22 to the tool 16.

At step 166 sensors such as, for example, the ply temperature sensor 120, the release point sensor 122, and the like are monitored. In this manner, the temperature of, at least, the ply material 22 and/or the backing 24 are determined.

At step 168 it is determined whether the temperature is suitable. For example, if the temperature of the ply material 22 at the tack point (tempt) is between a predetermined high tempₜₚ (temp_{high-tp}) and a predetermined low tempₜₚ (temp_{low-tp}) then it is determined that the tempₜₚ is suitable. If it is determined that the tempts is suitable, then the ply material 22 is tacked to the tool 16 at step 172. If it is determined that the tempₜₚ is not suitable then, at step 170, the tempt is modulated.

At step 170 the tempₜₚ is modulated. For example, if the tempt is below the temp_{low-tp} then, the nip heater 124 and/or the chute heater 126 is controlled to increase the amount of thermal energy imparted upon the ply material 22. If the tempₜₚ is above the temp_{high-tp} then, the nip heater 124 and/or the chute heater 126 is controlled to decrease the amount of thermal energy imparted upon the ply material 22.

At step 172 the backed ply material 20 is advanced until the start of the ply material 22 is correctly positioned and the tape laying head 14 is positioned appropriately with regard to the initial point determined at step 158. For example, the take up reel 32 and/or the supply spool 30 may be controlled to advance the backing 24 through the tape laying head 14 until an end of the ply material 22 is positioned between the compaction roller 34 and the tool 16. In another example, the rollers of the material feeder 40 may engage the backed ply material 20 and advance the ply through the tape laying head 14 until the backed ply material 20 is positioned to be applied to the tool 16, referred to as being tacked. To ensure the backed ply material 20 has advanced a suitable amount, a sensor and/or operator may sense the position of the backed ply material 20. In addition, the location on the tool 16 is determined based upon the series of computer readable instruction and/or the location of a previously positioned ply material 22. Furthermore, the backed ply material 20 is tacked to the substrate. In an embodiment of the invention, the backed ply material 20 is tacked by positioning the tape laying head 14 with the CTLM 10 such that the compaction roller 34 or a shoe is controlled to press the backed ply material 20 on to the tool 16 or substrate with sufficient force so as to cause the backed ply material 20 to adhere to the substrate. In this regard, the substrate refers to the tackifier applied to the tool 16 at step 152 and/or previously applied ply material 22.

At step 174, the backed ply material 20 is dispensed along a path across the tool 16. In order to minimize deformations in the backed ply material 20 (e.g., wrinkles), this path is typically calculated to coincide with a “natural path” based upon any contours in the tool 16. This natural path and/or movement instructions based upon the natural path is included in the file 104 and utilized to modulate the axis servos 118a-118n as the tape laying head 14 is controlled along the path across the tool 16. As the tape laying head 14 moves along the path, the backed ply material 20 is drawn out of the tape laying head 14. The rate at which the backed ply material 20 is withdrawn is referred to as the “feed rate.” In addition, the compaction roller 34 is caused to exert sufficient pressure so as to adhere or consolidate the ply material 22 to the tool 16. In this regard, composite layups typically include multiple layers of ply material. Thus, in subsequent applications of the ply material 22, backed ply material 20 is dispensed upon previously applied ply material. Furthermore, according to various embodiments, the placement of the backed ply material 20 on the tool 16 is evaluated as, or shortly after, it is being applied to the substrate. For example, a sensor or an operator may sense the relative position of the backed ply material 20 and a previously positioned backed ply material 20 and determine if the distance between these plies is within a predetermined tolerance. If the distance between these plies is not within the predetermined tolerance, an error may be generated.

In some embodiments of the invention, the backing 24 is removed from the backed ply material 20 following placement and/or placement evaluation. However, the backing 24 need not be removed prior to step 176, but rather, the backing 24 may be removed at essentially any time prior to placement of a subsequent ply upon the backed ply material 20. Furthermore, it is an advantage of embodiments of the invention that the backing 24 is recyclable. That is, the backing 24 may be collected and submitted to a recycling facility where the PET constituent of the backing 24 may be processed to generate products. For the purpose of this disclosure, the term, “recycling” is defined as the act of collecting the backing 24 for submission to a recycling facility and/or the reprocessing of the backing 24.

At step 176 heat is applied to one or more locations. For example, heat may be applied at the heater assembly 38, the guide chute 42, and/or the like. In particular, the nip heater 124 and/or the chute heater 126 are modulated by the controller 100 to apply heat to the backed ply material 20. According to an embodiment, as the feed rate increases, a relatively greater amount of heat is applied. For example, at a feed rate of about zero meters per second, the nip heater 124 and the chute heater 126 are controlled to stop generating heat. As the speed increases, the nip heater 124 is controlled to increase the amount of heat applied. As the speed increases further still, the nip heater 124 and the chute heater 126 are controlled to increase the amount of applied heat. In this manner, the temperature of the ply material 22 may be maintained between a predetermined high temperature and a predetermined low temperature. These temperatures are dependent upon the particular ply material utilized. In a specific example, the predetermined high temperature is about 160° F. and the predetermined low temperature is about 130° F.

At step 178 sensors such as, for example, the ply temperature sensor 120, the release point sensor 122, and the like are monitored. In this manner, the temperature of, at least, the ply material 22 and/or the backing 24 are determined. In addition, based upon the rotational speed of the supply spool 30 and/or the take-up reel 32, the feed rate may be determined.

At step 180 it is determined whether the temperature is suitable. For example, it is determined if the tempt is between the temp_{high-tp} and the temp_{low-tp}. In another example, it is determined whether the backing 24 is at a suitable temperature. That is, if the temperature of the backing 24 (temp_{back}) exceeds a predetermined high temp_{back} (temp_{high-back}) then the temp_{back} is modulated at step 182. If it is determined that the tempₜₚ, temp_{back}, and the like are suitable, then it is determined if an end of the path has been reached at step 184. If it is determined that the tempₜₚ, temp_{back}, and/or the like are not suitable then, at step 182, the one or more unsuitable temperature is modulated.

At step 182 the tempₜₚ is modulated. For example, if the tempₜₚ is below the temp_{low-tp} then, the nip heater 124 and/or the chute heater 126 is controlled to increase the amount of thermal energy imparted upon the ply material 22. If the tempₜₚ is above the temp_{high-tp} then, the nip heater 124 and/or the chute heater 126 is controlled to decrease the amount of thermal energy imparted upon the ply material 22. Similarly, in another example, if the temp_{back} is above the temp_{high-back} then, the release point blower 128 is controlled to remove excessive thermal energy from the backing 24.

At step 184, it is determined if the end of the path has been reached. If, based on the series of computer readable instruction included in the file 104, it is determined the tape laying head 14 has not advanced to the end of the path, additional backed ply material 20 is dispensed at step 174. If, it is determined the tape laying head 14 has advanced to the end of the path, the backed ply material 20 is cut at step 188.

At step 188 the ply material 22 is cut in accordance with the profile specified in the file 104. For example, the supply reel servo 114, the take-up reel servo 116, and/or the cutting assembly 36 may be modulated via the controller 100 to perform the cut as specified in the file 104. In a particular example, cutting of the ply material 22 may be performed at a controlled depth of cut so as to substantially sever the ply material 22 while leaving the backing 24 essentially uncut.

At step 190, it is determined if the placement of the ply material 22 on the tool 16 has been completed. For example, if all of the movement instruction encoded in the file 104 have been completed, it may be determined that the placement of plies for the composite product has been completed and the CTLM 10 may idle until another series of computer readable instructions is initiated. If is determined the placement of ply material 22 for the composite product is not completed, an additional ply material 22 placement may proceed at step 158.

Following the method 150, the composite product may be cured in any suitable manner. In the aerospace industry, thermoset resins are generally utilized to pre-impregnate ply material. These thermoset resins are typically cured by being held at an elevated temperature for a predetermined amount of time. Times and temperatures may be selected depending on the resin used, the size and thickness of the composite product, and the like.

Although an example of the CTLM 10 and tape laying head 14 is shown utilizing the backed ply material 20 for composite products in the airline industry, the backed ply material 20 can also be used in other industries that construct composite product. These industries include, but are not limited to, automobile, marine, spacecraft, building, and consumer products.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method of generating a laminated item from a ply placed on a layup form, the method comprising:
applying a tackifier to the layup form;
determining a first location on the layup form to place the ply;
determining a second location on the layup form to stop placing the ply;
cutting the ply to generate a first edge that substantially conforms to the layup form at the first location in response to the first edge being different from the layup form at the first location;
modulating a temperature of the ply;
tacking the first edge to the layup form at the first location;
applying the ply along a natural path of the layup form between the first location and the second location; and
cutting the ply to generate a second edge that substantially conforms to the layup form at the second location in response to the second edge being different from the layup form at the second location.

2. The method according to claim 1, wherein applying the tackifier to the layup form further comprises:
applying a resin diluted from about 2% to about 50% weight to volume in a solvent; and
allowing the solvent to flash off.

3. The method according to claim 2, wherein applying the tackifier to the layup form further comprises:
applying a Toray E-09 resin diluted to about 22% weight to volume in acetone.

4. The method according to claim 2, wherein applying the tackifier to the layup form further comprises:
applying a MSR 355-HSC resin diluted to about 10% weight to volume in acetone.

5. The method according to claim 1, wherein determining the first location and the second location further comprises:
determining a set of parameters for the composite item, the set of parameters comprising:
generating a computer readable model of the composite item;
defining a surface of the layup form;
defining a plurality of layup form edges;
defining at least one composite item thickness;
generating a source code in response to the set of parameters; and
generating a set of movement instructions in response to the source code.

6. The method according to claim 5, wherein cutting the ply to generate the first edge and the second edge further comprises:
accessing the set of movement instructions;
modulating the ply in response to the movement instructions; and
modulating a cutting assembly in response to the movement instructions.

7. The method according to claim 5, wherein tacking the first edge further comprises:
accessing the set of movement instructions; and
modulating a plurality of actuators in a lamination device in response to the set of movement instructions.

8. The method according to claim 5, wherein applying the ply along the natural path further comprises:
accessing the set of movement instructions; and
modulating a plurality of actuators in the lamination device in response to the set of movement instructions.

9. The method according to claim 1, wherein modulating the temperature of the ply further comprises:
sensing a ply temperature;
sensing a ply speed;
applying heat to the ply in response to the ply being below a predefined minimum ply temperature; and
modifying the applied heat in response to the speed of the ply.

10. The method according to claim 9, wherein modifying the applied heat further comprises:
reducing the applied heat in response to the ply speed being relatively slow; and
increasing the applied heat in response to the ply speed being relatively fast.

11. An apparatus for generating a composite item from a ply placed on a layup form, the apparatus comprising:
means for applying a tackifier to the layup form;
means for determining a first location on the layup form to place the ply;
means for determining a second location on the layup form to stop placing the ply;
means for cutting the ply to generate a first edge that substantially conforms to the layup form at the first location in response to the first edge being different from the layup form at the first location;
means for modulating a temperature of the ply;
means for tacking the first edge to the layup form at the first location;
means for applying the ply along a natural path of the layup form between the first location and the second location; and
means for cutting the ply to generate a second edge that substantially conforms to the layup form at the second location in response to the second edge being different from the layup form at the second location.

12. The apparatus according to claim 11, wherein the means for applying the tackifier to the layup form further comprises:
means for applying a resin diluted from about 2% to about 50% weight to volume in a solvent; and
means for allowing the solvent to flash off.

13. The apparatus according to claim 12, wherein the means for applying the tackifier to the layup form further comprises:
means for applying a Toray E-09 resin diluted to about 22% weight to volume in acetone.

14. The apparatus according to claim 12, wherein the means for applying the tackifier to the layup form further comprises:
means for applying a MSR 355-HSC resin diluted to about 10% weight to volume in acetone.

15. The apparatus according to claim 11, wherein the means for determining the first location and the second location further comprises:
means for determining a set of parameters for the composite item, the set of parameters comprising:
means for generating a computer readable model of the composite item;
means for defining a surface of the layup form;
means for defining a plurality of layup form edges;
means for defining at least one composite item thickness;
means for generating a source code in response to the set of parameters; and
means for generating a set of movement instructions in response to the source code.

16. The apparatus according to claim 15, wherein the means for cutting the ply to generate the first edge and the second edge further comprises:
means for accessing the set of movement instructions;
means for modulating the ply in response to the movement instructions; and
means for modulating a cutting assembly in response to the movement instructions.

17. The apparatus according to claim 15, wherein tacking the first edge further comprises:
means for accessing the set of movement instructions; and
modulating a plurality of actuators in a lamination device in response to the set of movement instructions.

18. The apparatus according to claim 15, wherein the means for applying the ply along the natural path further comprises:
means for accessing the set of movement instructions; and
means for modulating a plurality of actuators in the lamination device in response to the set of movement instructions.

19. The apparatus according to claim 11, wherein the means for modulating the temperature of the ply further comprises:
means for sensing a ply temperature;
means for sensing a ply speed;
means for applying heat to the ply in response to the ply being below a predefined minimum ply temperature; and
means for modifying the applied heat in response to the speed of the ply.

20. The apparatus according to claim 19, wherein the means for modifying the applied heat further comprises:
means for reducing the applied heat in response to the ply speed being relatively slow; and
means for increasing the applied heat in response to the ply speed being relatively fast.

21. A computer readable medium on which is embedded computer software comprising a set of instructions for executing a method of generating a composite item from a ply placed on a layup form, the method comprising:
applying a tackifier to the layup form;
determining a first location on the layup form to place the ply;
determining a second location on the layup form to stop placing the ply;
cutting the ply to generate a first edge that substantially conforms to the layup form at the first location in response to the first edge being different from the layup form at the first location;
modulating a temperature of the ply;
tacking the first edge to the layup form at the first location;
applying the ply along a natural path of the layup form between the first location and the second location; and
cutting the ply to generate a second edge that substantially conforms to the layup form at the second location in response to the second edge being different from the layup form at the second location.

22. The medium according to claim 21, wherein applying the tackifier to the layup form further comprises:
applying a resin diluted from about 2% to about 50% weight to volume in a solvent; and
allowing the solvent to flash off.

23. The medium according to claim 22, wherein applying the tackifier to the layup form further comprises:
applying a Toray E-09 resin diluted to about 22% weight to volume in acetone.

24. The medium according to claim 22, wherein applying the tackifier to the layup form further comprises:
applying a MSR 355-HSC resin diluted to about 10% weight to volume in acetone.

25. The medium according to claim 21, wherein determining the first location and the second location further comprises:
determining a set of parameters for the composite item, the set of parameters comprising:
generating a computer readable model of the composite item;
defining a surface of the layup form;
defining a plurality of layup form edges;
defining at least one composite item thickness;
generating a source code in response to the set of parameters; and
generating a set of movement instructions in response to the source code.

26. The medium according to claim 25, wherein cutting the ply to generate the first edge and the second edge further comprises:
accessing the set of movement instructions;
modulating the ply in response to the movement instructions; and
modulating a cutting assembly in response to the movement instructions.

27. The medium according to claim 25, wherein tacking the first edge further comprises:
accessing the set of movement instructions; and
modulating a plurality of actuators in a lamination device in response to the set of movement instructions.

28. The medium according to claim 25, wherein applying the ply along the natural path further comprises:
accessing the set of movement instructions; and
modulating a plurality of actuators in the lamination device in response to the set of movement instructions.

29. The medium according to claim 21, wherein modulating the temperature of the ply further comprises:
sensing a ply temperature;
sensing a ply speed;
applying heat to the ply in response to the ply being below a predefined minimum ply temperature; and
modifying the applied heat in response to the speed of the ply.

30. The medium according to claim 29, wherein modifying the applied heat further comprises:
reducing the applied heat in response to the ply speed being relatively slow; and
increasing the applied heat in response to the ply speed being relatively fast.

31. A system for generating a composite item from a ply placed on a layup form, the system comprising:
a contour tape lamination machine to move a dispensing head along a natural path across the layup form, the dispensing head comprising:
a supply reel to retain a supply of the ply, wherein the ply is withdrawn from the supply reel at a feed rate; and
a heater assembly, the heater assembly being operable to impart thermal energy upon the ply in response to the feed rate.

32. The system according to claim 31, further comprising:
a cutting assembly to cut the ply according to a predetermined profile, the cutting assembly comprising:
an anvil for providing support to the ply being cut by an ultrasonic blade, the ultrasonic blade having a tip, the ultrasonic blade being operable to travel along a blade path, the blade path being oriented in a transverse manner relative to the ply, the anvil comprising:
a rigid base for securing the anvil to a cutting assembly;
a surface coinciding with the blade path, the surface being secured to the base; and
a groove disposed upon the surface, the groove being in cooperative alignment with the tip, wherein the cutting assembly is operable to cut the ply without substantially cutting a backing film for the ply.

33. The system according to claim 32, further comprising:
a ply sensor to sense a temperature of the ply, wherein the heater assembly is further configured to modulate the amount of heat imparted upon the ply in response to the sensed temperature of the ply.

34. The system according to claim 33, further comprising:
a backing sensor to sense a temperature of the backing film, the temperature of the backing film being sensed at a backing release point; and
a blower to reduce the temperature of the backing film in response the sensed temperature of the backing film being above a predetermined value.

35. The system according to claim 34, wherein the ply includes a metal foil.

36. The system according to claim 35, wherein the backing film comprises polyethylene terephthalate.
